(19) United States
(12) Patent Application Publication
(10) Pub. No.: US 2009/0040287 A1
(43) Pub. Date: Feb. 12, 2009

(54) VIDEO COMMUNICATION DEVICE AND VIDEO COMMUNICATION METHOD

(75) Inventor: Toru Miyazaki, Fukaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/047,155

(22) Filed: Mar. 12, 2008

(30) Foreign Application Priority Data
Mar. 30, 2007 (JP) 2007-091658

(51) Int. Cl. H04N 7/14

(52) U.S. Cl. 348/14.01; 348/E07.077

(57) ABSTRACT

According to one embodiment, there is provided a video communication device including a first communication unit which conducts communication of management information with an external device through a cable at a first communication speed, a second communication unit which conducts communication of a video signal with the external device through the cable at a second communication speed higher than the first communication speed, a detector which detects an error signal by observing a communication situation with the external device, and a generating unit which generates an image signal indicating the communication situation based on the error signal detected by the detector.

### CROSS-REFERENCE TO RELATED APPLICATION

This application is based upon and claims the benefit of priority from Japanese Patent Application No. 2007-091658, filed Mar. 30, 2007, the entire contents of which are incorporated herein by reference.

### BACKGROUND

1. Field

One embodiment of the present invention relates to a video communication device having a communication function for transmitting and receiving data at a plurality of transfer rates, and in particular to a video communication device and a video communication method having a function of displaying the communication situation.

2. Description of the Related Art

Recent years have seen a remarkable extension of the ownership and use of digital devices having mutual communication functions capable of collaborative operation. These digital communication functions, however, operate not necessarily in stable fashion constantly, and the communication is desirably continued by taking an appropriate action in case of a communication error.

Patent Document 1 (Jpn. Pat. Appln. KOKAI Publication No. 2000-101605) discloses a technique relating to an infrared ray video communication device having the function of calculating the communication quality and the function of changing the communication speed in accordance with the result of communication quality calculation.

According to the conventional technique described in Patent Document 1, however, the communication is changed in speed or suspended automatically in accordance with the communication quality. In the digital video communication such as HDMI, on the other hand, even though somewhat low in communication quality, the video signal format of the same type may be used as it is. In many cases, therefore, the communication situation should be better indicated to the user thereby to allow the user to take an appropriate action rather than to change the communication speed or suspend the communication.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing an example of the configuration of a source-side video communication device having a communication situation display function and a sink-side video communication device having the communication situation display function according to an embodiment of the invention;

FIG. 2 is a diagram for explaining an HDMI terminal handled by the video communication device according to an embodiment of the invention;

FIG. 3 is a diagram for explaining a display port handled by the video communication device according to an embodiment of the invention;

FIG. 4 is a block diagram showing an example of the configuration of the source-side video communication device having the communication situation display function and the sink-side video communication device having no communication situation display function according to an embodiment of the invention;

FIG. 5 is a block diagram showing an example of the configuration of the source-side video communication device having no communication situation display function and the sink-side video communication device having the communication situation display function according to an embodiment of the invention;

FIG. 6 is a flowchart showing an example of a communication situation display process executed by the source-side video communication device according to an embodiment of the invention;

FIG. 7 is a flowchart showing an example of a communication situation display process executed by the sink-side video communication device according to an embodiment of the invention;

FIG. 8 is a diagram for explaining an example of communication error display executed by the video communication device according to an embodiment of the invention;

FIG. 9 is a diagram for explaining another example of the communication error display executed by the video communication device according to an embodiment of the invention;

FIG. 10 is a diagram for explaining another example of the communication error display executed by the video communication device according to an embodiment of the invention; and

FIG. 11 is a block diagram showing an example of the configuration of a broadcast receiver as a specific example of the video communication device according to an embodiment of the invention.

### DETAILED DESCRIPTION

Various embodiments according to the invention will be described hereinafter with reference to the accompanying drawings. In general, according to one embodiment of the invention, there are provided a video communication device and a video communication method for displaying the communication situation in the digital video communication such as HDMI.

One embodiment for achieving the object is a video communication device comprising:

a first communication unit (17) which conducts communication of management information with an external device through a cable at a first communication speed;

a second communication unit (16) which conducts communication of a video signal with the external device through the cable at a second communication speed higher than the first communication speed;

a detector (11, 12) which detects an error signal by observing a communication situation with the external device; and

a generating unit (13) which generates an image signal indicating the communication situation based on the error signal detected by the detector.

The communication quality of the communication cable used is displayed on the digital TV screen, for example, linked to each video signal format such as 480p, 1080i or 1080p, and therefore, the user can conduct the communication with the optimum video signal in the range available for the particular communication cable.

Embodiments of this invention will be explained in detail below with reference to the drawings.

(Example of Digital Video Communication Having Plural Communication Speeds)

First, the digital video communication having a plurality of communication speeds used by a video communication device according to an embodiment of this invention will be explained below.

In the case where a communication error occurs in the digital data communication typically conducted by the computer, the communication quality is secured normally by recognizing the communication error at the transmitting and receiving ends and executing the retransmission process. In the digital video communication typically using HDMI, however, an error, if any, developed in a part of the video data, though a cause of a noise on the screen, has no such an effect as to destroy the entire video service and the data is not retransmitted.

Typical methods of digital video signal transmission include HDMI (high-definition multimedia interface) and DVI (digital visual interface), and a new transmission method such as DP (display port) has been proposed as a method which is expected to become a reality in the near future. Generally, a new method is standardized to transmit an image with a higher resolution and requires a correspondingly higher quality of the cable as well as the transmitter/receiver.

In HDMI, the cable quality can be set arbitrarily in design stage. By employing the quality test for authentication, however, the trouble which otherwise might occur at the time of user operation is avoided. Actually, however, it is unrealistic to test all the cables. Further, with the progress toward a higher definition of the digital video format, a plurality of types of data transfer rate are specified to such an extent that the communication quality now depends also on the transmission video format (data transfer rate).

For example, a cable capable of communication for 1080i without any problem may develop an error at 1080p. According to HDMI Ver1.3 recently standardized, a method of transmitting the more finely detailed digital signal called DeepColor has been defined. In this method, though having the same resolution as the conventional HDMI Ver1.2a, the fine video data transfer requires the definition of the actual transfer rate of the digital signal up to 3.4 Gbps or about twice as large as in the prior art.

In the world of the digital video communication typically using HDMI, the video format capable of being received at the receiving end can be read at the transmitting end using a low-speed communication path different from the digital video signal. This communication path is low in speed, and the requirement for communication quality is met by the cable quality lower than for the high-speed digital video communication.

In the ordinary video communication device, however, the communication quality is not measured for both the transmitter and the receiver, and consequently, the transmitter selectively transmits data of a high image quality based on the receivable format information obtained on the low-speed communication path. Depending on the cable quality, therefore, a screen anomaly may develop and the proper transmission situation cannot be recognized by the user.

In the video communication device according to an embodiment of the invention, the communication situation of the communication cable, etc. is displayed in the state linked to, for example, the video signal format, and therefore, the user can conduct the optimum video signal communication in the range usable with the particular communication cable.

<Video Communication Device According to an Embodiment of the Invention>

Next, an example of the video communication device according to an embodiment of the invention will be explained in detail with reference to the drawings. The embodiment described below discloses an example of the video communication device and the video communication method having the function of detecting and displaying the communication situation of the communication path for the digital video communication with HDMI as an example. This embodiment of the invention, however, is not limited to HDMI but may use other digital communication standards as well as a display port and widely applicable to digital communication.

(Configuration)

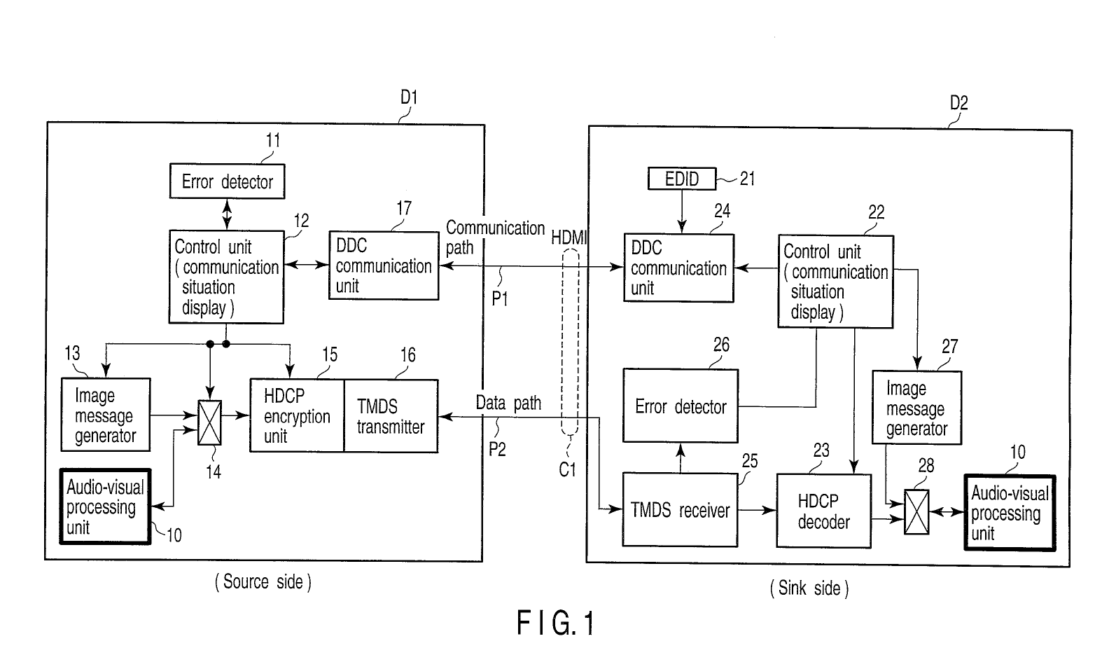

First, as shown in FIG. 1, an explanation is given about a communication system including a video communication device D1 having the communication situation display function and a video communication device D2 connected to the video communication device D1 with an HDMI cable C1 and having a similar communication situation display function. FIG. 1 is a block diagram showing an example of the configuration of a source-side video communication device having the communication situation display function and a sink-side video communication device having the communication situation display function according to an embodiment of the invention.

The video communication device D1 according to an embodiment of the invention, as shown in FIG. 1, includes an audio-visual processing unit 10, an error detector 11 for receiving a communication signal and a signal indicating the communication situation from the video communication device D2 and detecting the presence or absence of a communication error from the signals, a control unit 12 for observing the various operating conditions of the video communication device D1 (source) and controlling the generation of an image signal for indicating the communication situation, an image message generating unit 13 for generating an image signal to indicate the communication situation, and a multiplexer 14 for multiplexing the image message and the video signal. Further, the video communication device D1 includes an HDCP encryption unit 15 for preventing the illegal copy of the video signal, a TMDS transmitter 16 for transmitting the image data through a communication path P2 by changing it to an electrical signal specified for HDMI, and a DDC communication unit 17 for transmitting the data at low speed through a DDC line constituting a communication path P1.

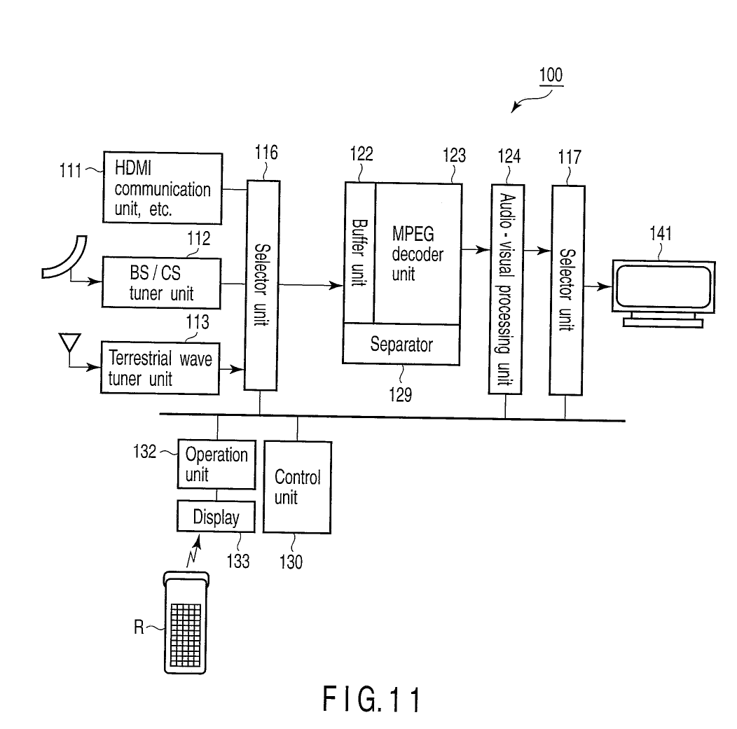

On the other hand, the video communication device D2 according to an embodiment of the invention, which is, for example, a digital TV having the HDMI communication function like a broadcast receiver 100 for displaying the broadcast signal described in FIG. 11, includes, as shown in FIG. 1, an EDID storage unit 21 for storing the EDID data to transmit the audio-visual format to the video communication device D1 and a DDC communication unit 24 for conducting the DDC line communication at low speed through the DDC line making up the communication path P1. Further, the video communication device D2 includes a TMDS receiver 25 for receiving a TMDS signal specified for HDMI, for example, and changing the TMDS signal to a signal adapted for the subsequent data processing, an error detector 26 for detecting a packet error or a jitter error from the TMDS receiver 25, a controller 22 for observing the communication situation of the video communication device D2 and supplying an error signal to the video communication device D1 through, for example, the DDC communication unit 24 or controlling generation of the image signal indicating the communication situation and the whole operation based on the error signal received from the video communication device D1 or the error signal detected by the error detector 26, an HDCP decoder 23 for decoding an HDCP encryption video signal supplied from the TMDS receiver 25 and an audio-visual processing unit 10 making up a main component such as the digital TV described later in FIG. 11, etc.

(HDMI Terminal and Display Port Terminal)

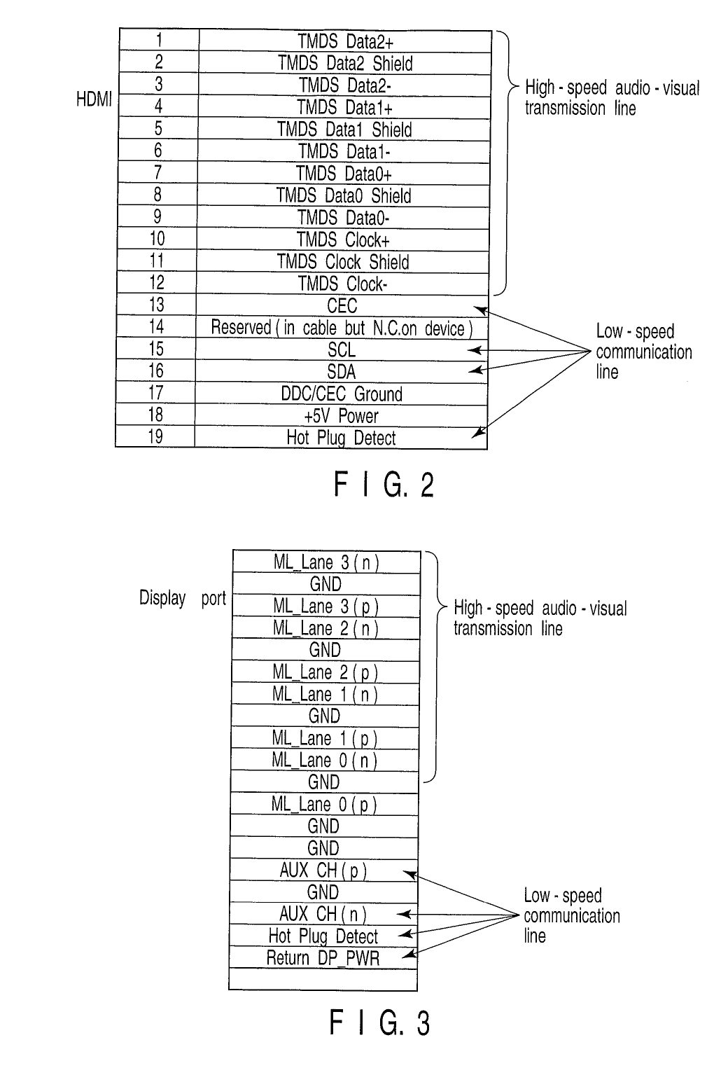

Next, the HDMI terminal and the display port terminal will be briefly explained with reference to FIGS. 2 and 3. Specifically, FIG. 2 is a diagram for explaining the HDMI terminals handled by the video communication device according to an embodiment of the invention, and FIG. 3 is a diagram for explaining the display port handled by the video communication device according to an embodiment of the invention.

The HDMI terminal handled by the video communication device according to an embodiment of the invention includes first to 12th terminals for the high-speed audio-visual transmission line, and 13th, 15th, 16th and 19th terminals for the low-speed communication line.

Similarly, as shown in FIG. 3, the first 11 terminals of the display port represent the high-speed audio-visual transmission line, and the last four terminals the low-speed communication line.

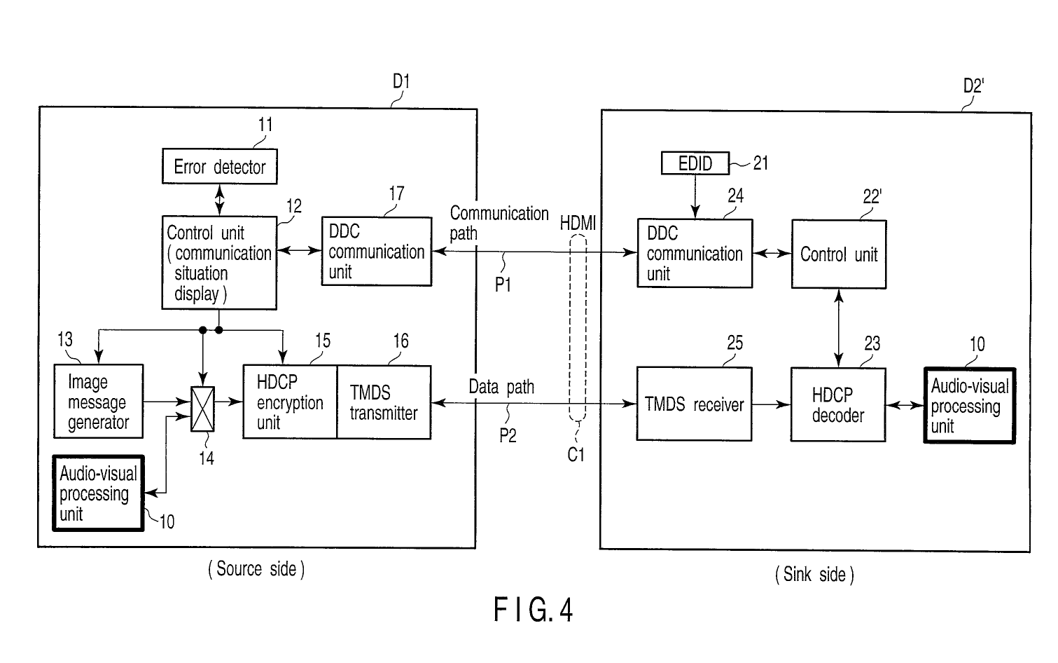

(Other Configuration: FIG. 4)

Next, as shown in FIG. 4, an explanation will be given about a communication system including a video communication device D1 having the communication situation display function and a video communication device D2′ having no communication situation display function and connected to the video communication device D1 by the HDMI cable C1. FIG. 4 is a block diagram showing an example of the configuration of the source-side video communication device having the communication situation display function and the sink-side video communication device having no communication situation display function according to an embodiment of the invention.

The video communication device D1 according to an embodiment of the invention has the same configuration as the corresponding device shown in FIG. 1 and is not explained again. Further, the video communication device D2′ having no communication situation display function is, for example, a digital TV having the HDMI communication function such as a broadcast receiver 100 for displaying the broadcast signal described later and shown in FIG. 11. The video communication device D2′ includes, as shown in FIG. 4, an EDID storage unit 21 for storing the EDID data to transmit the audio-visual format to the video communication device D1 and a DDC communication unit 24 for conducting the DDC line communication at low speed through the DDC line constituting the communication path P1. Further, the video communication device D2 includes a TMDS receiver 25 for receiving the TMDS signal specified for HDMI, for example, and changing the TMDS signal into a signal adapted for subsequent data processing, a control unit 22′ for controlling the overall operation, an HDCP decoder 23 for decoding the HDCP encryption video signal supplied from the TMDS receiver 25 and an audio-visual processing unit 10 constituting a main component such as the digital TV described later and shown in FIG. 11.

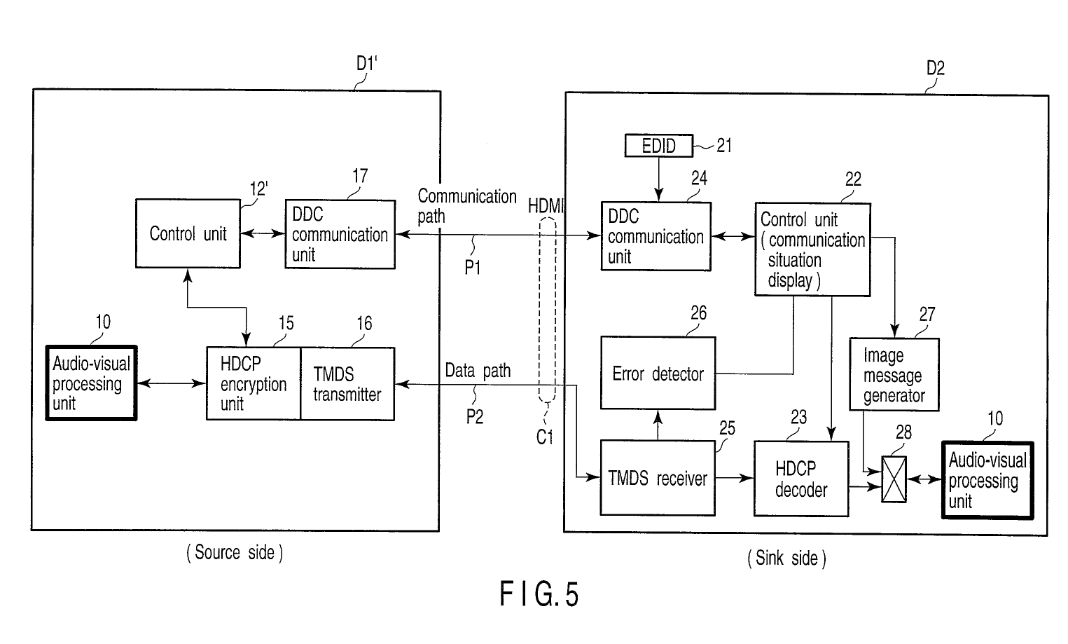

(Other Configuration: FIG. 5)

Next, as shown in FIG. 5, an explanation will be given about a communication system including a video communication device D1′ having no communication situation display function and a video communication device D2 having the communication situation display function and connected to the video communication device D1′ by the HDMI cable C1. FIG. 5 is a block diagram showing an example of the configuration of the source-side video communication device having no communication situation display function and the sink-side video communication device having the communication situation display function according to an embodiment of the invention.

The video communication device D1′ having no communication situation display function, as shown in FIG. 5, includes an audio-visual processing unit 10, a control unit 12′ for controlling the overall operation, an HDCP encryption unit 15 for preventing an illegal copy, etc. of the video signal, a TDMS transmitter 16 for transmitting the image data through a communication path P2 by changing it to an electrical signal specified for HDMI, and a DDC communication unit 17 for transmitting the data at low speed through the DDC line constituting the communication path P1.

Incidentally, the video communication device D2 according to an embodiment of the invention has the same configuration as the corresponding device shown in FIG. 1 and not described any more.

<Example of Communication Situation Display Process of Video Communication Device According to an Embodiment of the Invention>

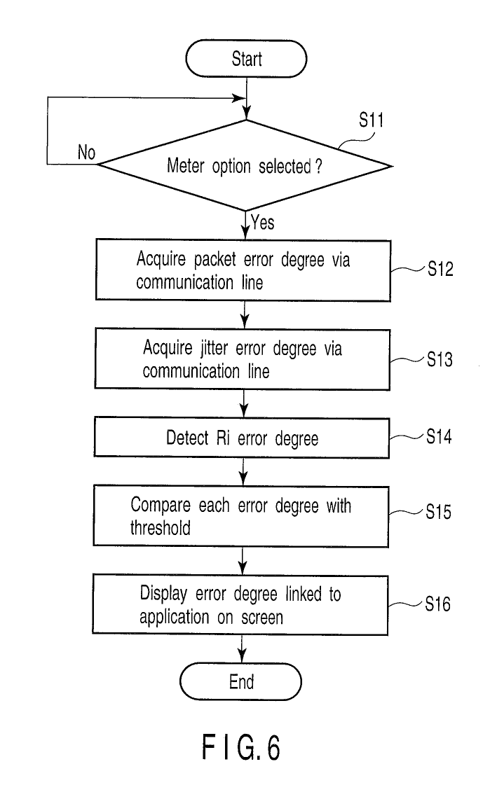

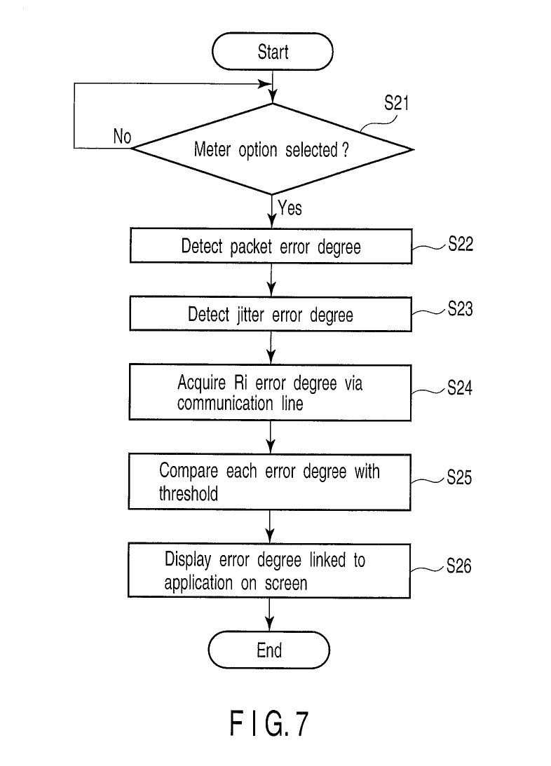

Next, an example of the communication situation display process of the video communication device according to an embodiment of the invention will be explained in detail with reference to the drawings. FIG. 6 is a flowchart showing an example of the communication situation display process executed by the source-side video communication device according to an embodiment of the invention, and FIG. 7 a similar flowchart showing an example of the communication situation display process executed by the sink-side video communication device according to an embodiment of the invention. In the flowcharts of FIGS. 6 and 7, each step can be replaced with a corresponding circuit block, and therefore, all the steps of the flowcharts can be redefined as circuit blocks, respectively.

Also, the embodiment described below represents a case in which the control unit is in charge of the steps of each operation. Nevertheless, the embodiments of the invention are not necessarily configured in such a manner, but an equivalent operation and effect can be achieved by each circuit configuration exhibiting the respective function without the control unit.

(Source-Side Communication Situation Display Process)

First, an example of the communication situation display process executed by the source-side video communication device D1 shown in FIGS. 1 and 4 will be explained with reference to the flowchart of FIG. 6. In the video communication device D1, as shown in the flowchart of FIG. 6, the control unit 12 judges whether an instruction has been given to select a meter option by a remote controller R or the like (not shown) (step S11). The control unit 12, upon judgment that an instruction has been given to select a meter option, tries to acquire a signal indicating the degree of the packet error from the video communication device D2, for example, through the DDC communication unit 17 and a communication line (step S12).

In the case where the party at the other end of communication is a control unit 22 having the error detector 26 or an error reporting function as shown in FIG. 1, the control unit 12 acquires the signal indicating the degree of the packet error. In the case where the other party of communication is a control unit 22′ having neither the error detector 26 nor the error reporting function as shown in FIG. 4, however, the control unit 12 acquires no signal indicating the degree of the packet error.

In similar fashion, the control unit 12 tries to acquire a signal indicating the degree of a jitter error from the video communication device D2, for example, through the DDC communication unit 17 and the communication line (step S13). In the case where the other party of communication is the control unit 22 having the error detector 26 or the error reporting function as shown in FIG. 1, the control unit 12 acquires the signal indicating the degree of the jitter error. In the case where the other party of communication is the control unit 22′ having neither the error detector 26 nor the error reporting function as shown in FIG. 4, however, the control unit 12 acquires no signal indicating the degree of the jitter error.

Next, the error detector 11 detects the degree of an Ri error under the control of the control unit 12. Now, the packet error, the jitter error and the Ri error will be explained.

The packet error is given by an error correction code or the like in an HDMI data island packet. This code can be monitored by the HDMI receiver (sink side), and based on this value, the error can be checked.

The error correction code for the high-speed data line is available and the communication error of the high-speed line (digital audio-visual transfer) can be monitored also according to the DP standard equipped with the high-speed data line and the low-speed data line as in the HDMI.

Now, the jitter error will be explained. According to HDMI or DP, the digital video signal is coded and transferred, and therefore, several data exist which are required to be transmitted at a specified timing. In each frame, a period exists, for example, during which the HDMI encryption is prohibited, and the limit of the start timing is specified. Also, the timing to transmit the information indicating the presence or absence of encryption is specified for each frame. These timings are not specified strictly for each Ck but with some degree of design freedom, and therefore, have some freedom. The normal transmission timing is often designed the same way for each frame, and in the case where the communication path poses a quality problem, the timing is not necessarily constant but may be somewhat shifted. By monitoring this shift, the jitter error can be observed.

Next, the random number Ri will be described. In the HDMI encryption process, when the HDCP encryption is used, the random number called Ri is required to be matched between transmission and receiving ends, and can be periodically observed at the transmission end (source side). The random number Ri is dependent on the TMDS line Ck and the encrypted pixel count, and in the case where the TMDS signal cannot be correctly received, the count is shifted and the received Ri is mismatched. Specifically, the communication situation can be confirmed by checking whether Ri is matched or not at the transmitting end (source side). At the receiving end (sink side), on the other hand, the Ri matching cannot be directly monitored. Upon occurrence of an Ri mismatch, however, the HDMI is rechecked. In this way, the error state can also be monitored.

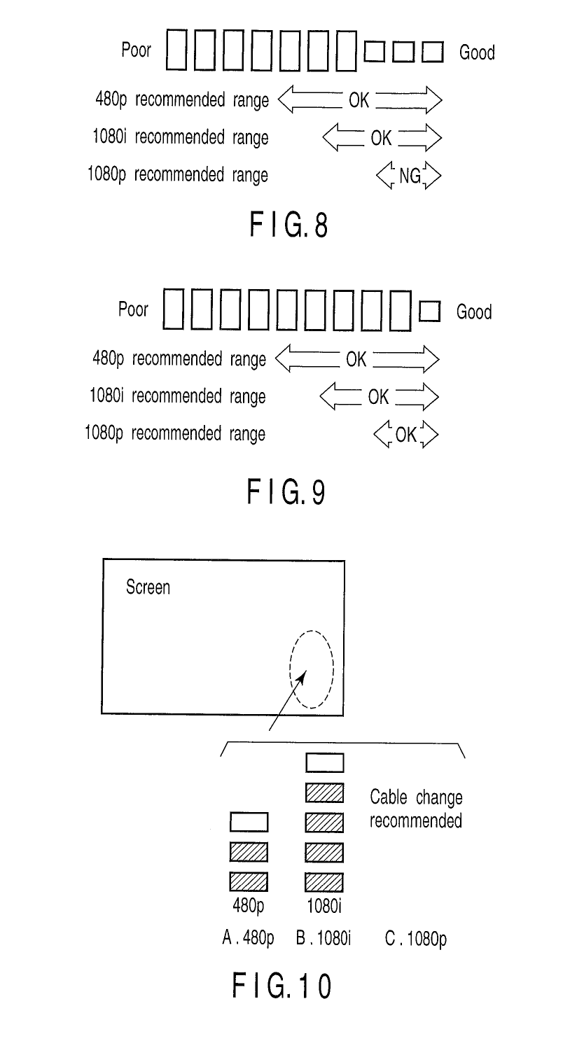

As described above, the control unit 12 collects the packet error, the jitter error and the Ri error. More preferably, however, the control unit 12 collects still other indexes of the communication situation. The control unit 12 compares the degree of each error signal with a preset threshold value (step S15), and in accordance with the comparison result, quantitatively evaluates the communication situation. As a result, the control unit 12 and the image message generating unit 13 generate an image signal indicating the communication situation as shown in FIGS. 8 to 10 (step S16). FIGS. 8 to 10 are diagrams for explaining an example of communication error display executed by the video communication device according to an embodiment of the invention.

Specifically, in FIG. 8, the communication situation is evaluated in ten stages on the assumption that the communication function is 70%. In the process, the relation with the video signal formats “480p”, “1080i” and “1080p” is preferably displayed on the screen.

The figure “480p” is one of the video signal formats for the digital TV broadcasting and represents an image of progressive scan type having 480 effective scanning lines and the frame frequency of 59.94 Hz. The number of pixels is 720×480 with the aspect ratio of 16:9. This is a kind of the SDTV video format having the same number of scanning lines as the current analog TV broadcasting.

The figure “1080i” is one of the video signal formats for the digital TV broadcasting and represents an image of interlace scan type having 1080 effective scanning lines and the frame frequency of 29.97 Hz. The number of pixels is 1920×1080 with the aspect ratio of 16:9. This is a kind of the HDTV video format.

The figure “1080p” is one of the video signal formats for the digital TV broadcasting and represents an image of progressive scan type having 1080 effective scanning lines and the frame frequency of 59.94 Hz. The number of pixels is 1920×1080 with the aspect ratio of 16:9. This is a kind of the HDTV video format.

In FIG. 8, the present communication quality having the video signal format of “480p” is indicated in a recommended range. Similarly, the present communication quality of the video signal format of “1080i” is also indicated in a recommended range. The present quality of the video signal format of “1080p”, however, is not indicated in the recommended range.

In a similar fashion, in FIG. 9, the communication situation is evaluated in ten stages on the assumption that the communication function is 90%. Further, with regard to the video signal format “480p”, the video signal format “1080i” and the video signal format “1080p”, the present communication quality is indicated in the recommended range for all the video signal formats.

Further, in the display example of the communication situation shown in FIG. 10, as indicated at the lower right corner of the TV screen or the like, the video signal formats “480p” and “1080i” are indicated to be in a tolerable range, while the cable change is recommended to the user for the video signal format “1080p”.

(Sink-Side Communication Situation Display Process)

Next, with reference to the flowchart of FIG. 7, an example of the communication situation display process executed by the sink-side video communication device D2 shown in FIGS. 1 and 5 will be explained. In the video communication device D2, as shown by the flowchart of FIG. 7, the control unit 22 judges whether an instruction is given by the remote controller R or the like, not shown, to select the meter option (step S21). The control unit 22, upon judgment that an instruction is given to select the meter option, controls the error detector 26 thereby to acquire the signal indicating the degree of the packet error (step S22). Then, the control unit 22 acquires the signal indicating the degree of the jitter error through the error detector 26 (step S23).

Further, as shown in FIG. 1, in the case where the other party of communication is the control unit 12 having the error reporting function or the error detector 11, the control unit 22 tries to acquire the signal indicating the degree of the Ri error. In the case where the other party of communication is the control unit 12′ having neither the error detector 11 nor the error reporting function as shown in FIG. 5, on the other hand, the control unit 22 acquires no signal indicating the degree of the Ri error. Incidentally, the video communication device at the receiving end (sink side) cannot directly monitor the Ri matching.

Once the Ri mismatch occurs, however, the HDMI is authenticated again, and therefore, the error state can be suitably monitored.

As described above, the control unit 22, though adapted to collect the packet error, jitter error and Ri error, more preferably collects other indexes of the communication situation. The control unit 22 compares the degree of each error signal with a preset threshold value (step S25), and in accordance with the comparison result, quantitatively evaluates the communication situation. As a result, the control unit 22 and the image message generating unit 27 generate an image signal indicating the communication situation as shown in FIGS. 8 to 10 (step S26).

In this way, the error signal indicating the error state is collected at the receiving end (sink side) as well as at the transmitting end (source side), so that the communication situation is displayed in a form easily understandable to the user as shown in FIGS. 8 to 10. As a result, the user can conduct the communication with the optimum video signal in the operable range of the communication cable.

<Broadcast Receiver Using Video Communication Device According to an Embodiment of the Invention>

Next, an example of the broadcast receiver using the video communication device according to an embodiment of the invention will be explained with reference to the drawings. FIG. 11 is a block diagram showing an example of the configuration of the broadcast receiver using the video communication device according to an embodiment of the invention.

Although the broadcast receiver is explained here taking the digital TV as an example, the video communication device according to an embodiment of the invention includes various forms all of which should be interpreted to be included in the scope of the embodiments of the invention.

In the broadcast receiver 100 shown in FIG. 11, the configuration other than the audio-visual processing unit 10 of the video communication device D1 or D2 according to an embodiment of the invention described above corresponds to the communication unit 111. Specifically, the communication unit 111 has the communication function such as the HDMI or the display port explained earlier with reference to FIGS. 1, 4 and 5.

Now, the broadcast receiver 100 shown in FIG. 11 includes, as main component elements, an MPEG decoder unit 123 for the broadcast reproduction process and a control unit 130 for controlling the operation of the system proper. The broadcast receiver 100 includes an input-side selector unit 116 and an output-side selector unit 117. The input-side selector unit 116 is connected with a communication unit 111 such as LAN, HDMI described above or a display port, a BS/CS tuner unit 112 for what is called the satellite broadcast and a tuner unit 113 for what is called the terrestrial wave to output a signal to an encoder unit 121. Also, the BS/CS tuner unit 112 is connected with a satellite antenna, and the terrestrial wave tuner unit 113 with a terrestrial wave antenna. Also, the broadcast receiver 100 includes a buffer unit 122, an MPEG decoder unit 123, a separator 129 and a control unit 130 which are connected to the control unit 130 through a data bus. Further, the output of the selector unit 117 is connected to an external receiver 41 or supplied to an external device through an interface unit or the like, not shown, for communication with the external device.

Further, the broadcast receiver 100 is connected to the control unit 130 through a data bus, and has an operating unit 132 for user operation and the operation of a remote controller R. The remote controller R can operate substantially the same way as the operating unit 132 of the broadcast receiver 100 proper, and is capable of various setting operations including tuner operation and recording reservation.

As described above, the video communication device according to an embodiment of the invention is applicable as a communication unit of the broadcast receiver (digital TV or the like) having the aforementioned configuration. According to this embodiment, the communication quality of the communication cable used for HDMI or the like is displayed on the screen of a digital TV, for example, in correspondence with the video signal formats of 480p, 1080i, 1080p. etc. As a result, the user can conduct the communication with the optimum video signal within the range operable through the communication cable.

With the various embodiments described above, those skilled in the art can implement the present invention. Further, it is easy for those skilled in the art to conceive various modifications of these embodiments, and without any special inventive ability, applications to various embodiments are possible. This invention, therefore, covers a wide scope not in conflict with the disclosed principle and the novel features and is not limited to the embodiments described above.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video communication device comprising:
a first communication unit which conducts communication of management information with an external device through a cable at a first communication speed;
a second communication unit which conducts communication of a video signal with the external device through the cable at a second communication speed higher than the first communication speed;
a detector which detects an error signal by observing a communication situation with the external device; and
a generating unit which generates an image signal indicating the communication situation based on the error signal detected by the detector.

2. The video communication device according to claim 1, wherein the cable used by the first communication unit and the second communication unit is selected one of an HDMI cable, a DVI cable and a DP cable.

3. The video communication device according to claim 1, wherein the generating unit displays the communication situation based on the error signal together with communicability in a predetermined video signal format.

4. The video communication device according to claim 1, wherein the generating unit displays the communication situation based on the error signal together with a recommended video signal format.

5. The video communication device according to claim 1, further comprising an encryption unit which encrypts and supplies the video signal to the second communication unit,
wherein the second communication unit supplies the encrypted video signal to the external device through the cable at the second communication speed higher than the first communication speed.

6. The video communication device according to claim 5, wherein the detector checks whether an Ri signal is matched or not between a transmitting end and a receiving end.

7. The video communication device according to claim 1, wherein the detector, through the first communication unit, detects a signal indicating a packet error or a data jitter error in the communication from the external device.

8. The video communication device according to claim 1, wherein the second communication unit receives the encrypted video signal from the external device through the cable at the second communication speed higher than the first communication speed, and
the second communication unit includes a decoder which decodes the encrypted video signal.

9. The video communication device according to claim 8, wherein the detector detects a packet error or a data jitter error in the communication with the external device.

10. The video communication device according to claim 8, wherein the detector, through the first communication unit, detects an Ri error signal in the communication with the external device, the Ri error signal shows an Ri signal is not match between a transmitting end and a receiving end.

11. The video communication device according to claim 8, further comprising a display which displays an image based on the video signal decoded by the decoder and the image signal indicating the communication situation.

12. A video communication method comprising:
conducting communication of management information with an external device through a cable at a first communication speed;
conducting communication of a video signal with the external device through the cable at a second communication speed higher than the first communication speed;
detecting an error signal by observing a communication situation with the external device; and
generating an image signal indicating the communication situation based on the error signal detected.
